(19) United States
(12) Patent Application Publication
(10) Pub. No.: US 2024/0426660 A1
(43) Pub. Date: Dec. 26, 2024

(54) VOLUMETRIC SILICON META-OPTICS FOR COMPACT AND LOW-POWER TERAHERTZ SPECTROMETERS

(71) Applicant: California Institute of Technology, Pasadena, CA (US)

(72) Inventors: Goutam Chattopadhyay, Pasadena, CA (US); Sven L. Van Berkel, Pasadena, CA (US); Subash Khanal, Pasadena, CA (US); Conner K. Ballew, Pasadena, CA (US)

(73) Assignee: California Institute of Technology, Pasadena, CA (US)

(21) Appl. No.: 18/749,191

(22) Filed: Jun. 20, 2024

Related U.S. Application Data
(60) Provisional application No. 63/521,941, filed on Jun. 20, 2023.

(51) Int. Cl. G01J 3/02; B82Y 20/00; B82Y 40/00; G01J 3/26; G02B 1/00

(52) U.S. Cl. CPC G01J 3/0259; B82Y 20/00; B82Y 40/00; G01J 3/0208; G01J 3/26; G02B 1/002

(57) ABSTRACT

A device including a stack of silicon meta-optical layers forming a meta-material comprising an input surface for receiving terahertz electromagnetic radiation, an output surface for outputting a plurality of beams of the electromagnetic radiation; and a spatially varying permittivity varying with sub-wavelength precision across a volume of the stack, wherein the spatially varying permittivity is configured to focus different spectral bands of the electromagnetic radiation into different spatially separated electromagnetic modes.

### CROSS-REFERENCE TO RELATED APPLICATIONS

This application claims the benefit under 35 U.S.C. Section 119 (e) of co-pending and commonly-assigned U.S. Provisional Patent Application No. 63/521,941, filed Jun. 20, 2023, entitled “VOLUMETRIC SILICON META-OPTICS FOR COMPACT AND LOW-POWER TERAHERTZ SPECTROMETERS” by Goutam Chattopadhyay, Sven L Van Berkel, Subash Khanal, and Conner K. Ballew, (CIT-9026) which application is incorporated by reference herein.

### FEDERALLY SPONSORED RESEARCH AND DEVELOPMENT

This invention was made with government support under Grant No. 80NMO0018D0004 awarded by NASA (JPL). The government has certain rights in the invention

### BACKGROUND OF THE INVENTION

### Field of the Invention

The present disclosure relates to meta-optical devices and methods and systems using the same.

### Description of the Related Art

The interaction of light with matter gives rise to spectral features that, like a fingerprint, can uniquely identify molecules. These spectral features propagate as electromagnetic waves, allowing molecular information to be characterized remotely by an instrument with sufficient spectral resolution. This technique is known as spectroscopy and is among the most critical techniques used in Earth, planetary, and astrophysics observations. The submillimeter-wave frequency range, spanning approximately 300 GHz to 3 THz, is a notoriously difficult range to work within. This lends it the name the “terahertz gap,” as the difficulties in scaling microwave technology to shorter wavelengths and scaling optical technology to longer wavelengths give rise to a frequency range wherein neither technology is adequate.

Certain facts of physics prevent the efficient scaling of technology to arbitrary frequency ranges. For example, non-superconducting metals inevitably become lossy as the frequency of operation increases. Many terahertz technologies today, including basic waveguides, rely on metallic structures and must accept the associated losses. State-of-the-art spectroscopy techniques involve heterodyning, which has as its basic ingredient one or more local oscillator signals, and it remains immensely challenging to both realize the required power over a broadband and scale such devices to many pixels. While progress is steadily being made on this front, new opportunities are arising for technologies that are uniquely suited for the terahertz range. Volumetric meta-optics are uniquely suited for the terahertz regime at present, given that 3D fabrication at higher frequency ranges remains complex. The present disclosure satisfies this need.

### SUMMARY OF THE INVENTION

The present disclosure describes a device, comprising a stack of silicon meta-optical layers forming a meta-material comprising an input surface for receiving terahertz electromagnetic radiation, an output surface for outputting a plurality of beams of the electromagnetic radiation; and a spatially varying permittivity varying with sub-wavelength precision across a volume of the stack, wherein the spatially varying permittivity is configured to focus different spectral bands of the electromagnetic radiation into different spatially separated electromagnetic modes.

Novel functionalities of the volumetric meta-optical device can be used to implement a novel type of spectrometer which utilizes spectral or color routing. In some embodiments, the spectrometer has substantially reduced size, mass, and power consumption.

In addition to the functionality used in the spectrometer system described herein, volumetric devices can be optimized to control all properties of light simultaneously. Polarization, spectral, and spatial properties can all be controlled by a single, wavelength-scale device over broad bands and with high efficiency. Realistically these devices could be used for many more terahertz applications, and the applications described herein are intended as illustrative experimentation of their use in realizing innovative new terahertz instruments.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1A illustrates the volumetric meta-optical device according to one or more embodiments and emission of the spatially separated electromagnetic modes.

FIG. 1B is a 3 dimensional (3D) view of volumetric meta-optical device comprising the stack of silicon layers.

FIG. 1C is a side view of volumetric meta-optical device comprising the stack of silicon layers and focusing of the spatially separated electromagnetic modes, into free space and a waveguide array (coupling in both scenarios has similar efficiency).

FIGS. 1D and 1E illustrates a measurement set up for characterizing the device under test (metal optical device) using a horn emitting terahertz electromagnetic radiation and a scanning probe positioned at focal plane (or fields can be computationally propagated to focal plane for a simulation).

FIG. 1F illustrates measurement of the spatial and frequency distribution of the electromagnetic modes emitted from the device, assuming no oxide between the silicon layers of the volumetric device (silicon to silicon bonding).

FIG. 1G and FIG. 1H compare measurement and simulation of the sorting efficiency and transmission of the electromagnetic modes from the device, respectively.

FIG. 1I illustrates a measurement of the spatially separated electromagnetic modes emitted from the meta-optical device at different frequencies.

FIG. 2A illustrates a spectrometer using a filter.

FIG. 2B illustrates a spectrometer using a diffraction grating.

FIG. 2C illustrates a spectrometer using the volumetric meta-optical device according to one or more embodiments described herein.

FIG. 2D illustrates the spectrum of the electromagnetic radiation at the various stages of transmission through the spectrometer of FIG. 2C.

FIG. 2E illustrates an electromagnetic mode focused by the volumetric device.

FIG. 3A is a 3D view of a spectrometer comprising the volumetric meta-optical device and a resonator.

FIG. 3B illustrates control (scanning) of the curved mirror in the resonator. For high-Q cavities, the mirrors need to be “curved” to confine beam to cavity.

FIGS. 3C and 3D illustrate measurement of the frequencies of the electromagnetic radiation outputted from the cavity a detector coupled to one of the electromagnetic modes, for cavities comprising mirrors with 2 DBR layers and 3 DBR layers mirrors respectively.

FIG. 4 illustrates coupling of a cavity comprising flat metasurface mirrors to the meta-optical device to form a metasurface-stabilized Fabry Perot cavity.

FIG. 5A is a close up view of a meta-optically stabilized FP cavity comprising flat mirrors.

FIG. 5B is a view of one of the flat mirrors.

FIG. 5C illustrates measurement of the Q factor of the FP cavity of FIG. 5A, showing extreme stability as evidenced by measurement of an atmospheric absorption limited Q factor. The resonators can be arrayed and spillover control can be used for eliminating higher-order Gaussian modes. The meta-optically stabilized Fabry-Perot cavity can also be characterized in a nitrogen atmosphere to find the maximum Q factor.

FIG. 5D illustrates a spectrometer comprising the volumetric meta-optical device coupled to a resonator comprising flat mirrors.

FIG. 5E is a second 3D view of the spectrometer of FIG. 6A in a compact configuration (4×4×9 cm).

FIG. 5F is a close up view of the volumetric device coupling to a split-block waveguide array.

FIG. 5G illustrates the FP resonator transmission when coupled to the volumetric device in the configuration of FIG. 6A, showing bandwidth of 500-650 GHz, spectral resolution of >10⁵, Δf<5 MHz and low-power, low speed piezo-tuning and DC signal readout. Measurement assuming no oxide layers between the silicon layers of the volumetric device.

FIG. 6A illustrates a first view spectrometer according to a second embodiment, wherein the resonator is coupled after the volumetric meta-optical device. Bandwidth of 430-600 GHz, spectral resolution of 10⁵, Δf˜500 KHz and low-power: 1 Watt low speed piezo-tuning and DC signal readout.

FIG. 6B illustrates detuning of the resonators.

FIGS. 6C and 6D plot measured S21 as a function of frequency, showing the frequency of two different electromagnetic modes.

FIG. 6E illustrates detection lines can be aligned with spectral lines of interest

FIG. 7 illustrates a method of fabricating the volumetric meta-optical device.

FIG. 8 is a close up view of the dies in the wafer after etching but prior to separation.

FIG. 9 illustrates the multiple layers of the meta-optical device comprising an 8 layer stack.

FIGS. 10A and 10B illustrate validation of the fabrication using vernier marks on edge (not shown) to measure layer-to-layer alignment of ±5 μm. Note: We regularly can achieve ±2 μm alignment and expect these devices can also be aligned with this to tolerance. The staircase stacking of the silicon layer helps confirm airgaps are eliminated by direct bonding.

FIG. 11 illustrates the device mounted on a mount using the pins that are inserted into through holes etched in the dies.

FIGS. 12A and 12B illustrate an adjoint method for topology optimization, wherein FIG. 12A illustrates the forward problem of a TE plane wave incident on a device and the device is designed to focus the incident TE plane wave by determining the permittivity distribution that maximizes the figure of merit FoM comprising intensity at a point. The resulting fields of the forward simulation are E_{fwd}. FIG. 12B illustrates the adjoint problem considering a dipole source whose amplitude is the complex conjugate of the forward field E_{fwd} evaluated at the position of the dipole. The resulting calculated fields of the adjoint simulation of the dipole source are E_{adj}. The method then evaluates the derivative ∂FoM/∂ε=Re(E_{fwd}×E_{adj}) at every point in the design region and uses gradient based optimization to iteratively find the permittivity ε distribution.

FIG. 13 illustrates how the differential of the figure of merit discussed in FIG. 12A-12B is calculated for three different dipoles emitting over different spectral bins and then combined as a weighted average to determine the spatial distribution of permittivity.

FIG. 14. Flowchart illustrating a method of making a device.

FIG. 15. Flowchart illustrating a method of using a device.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

### Technical Description

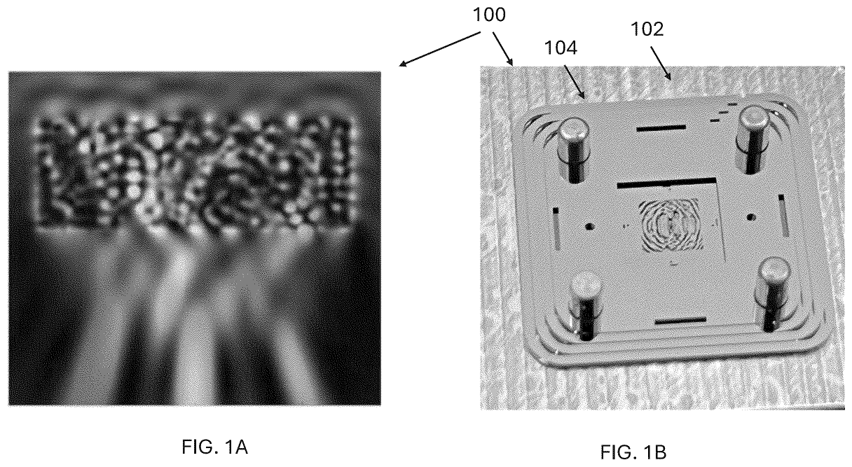

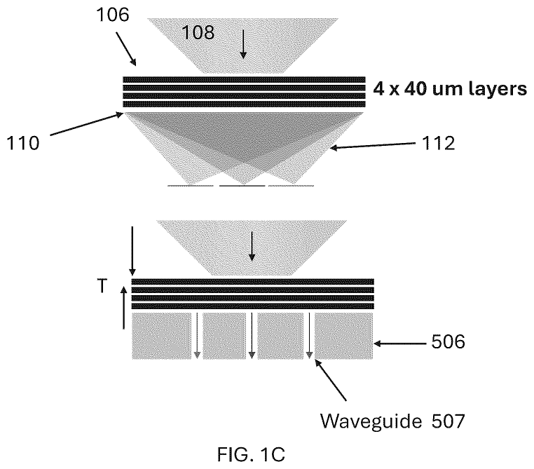

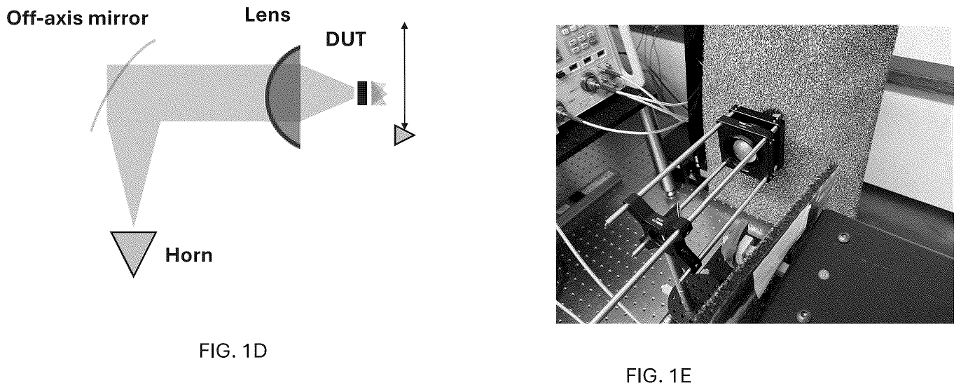

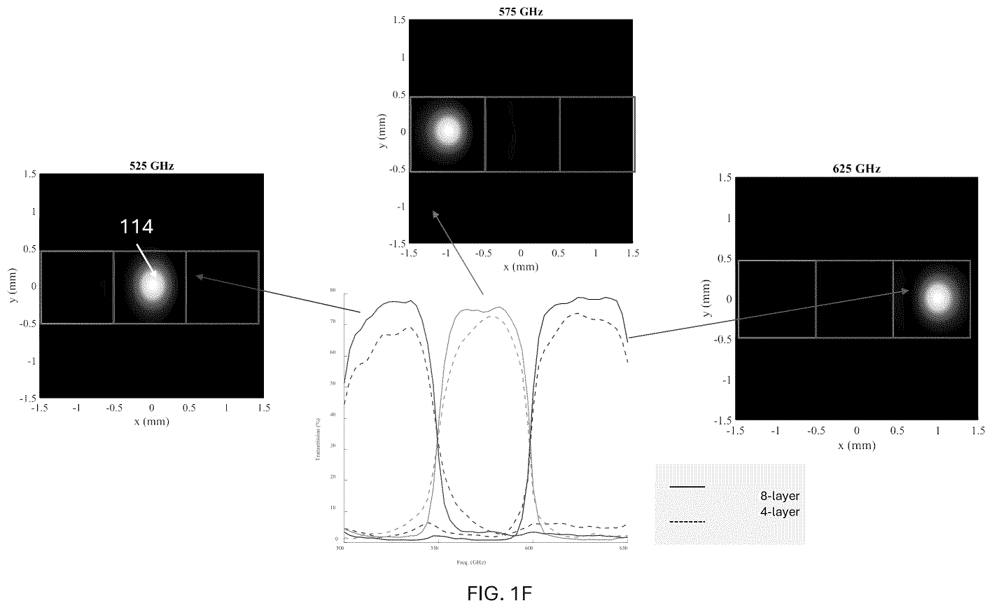

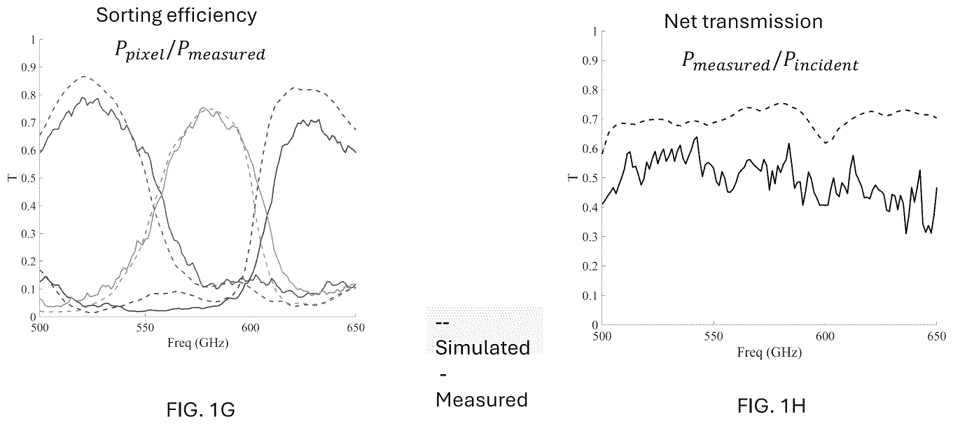

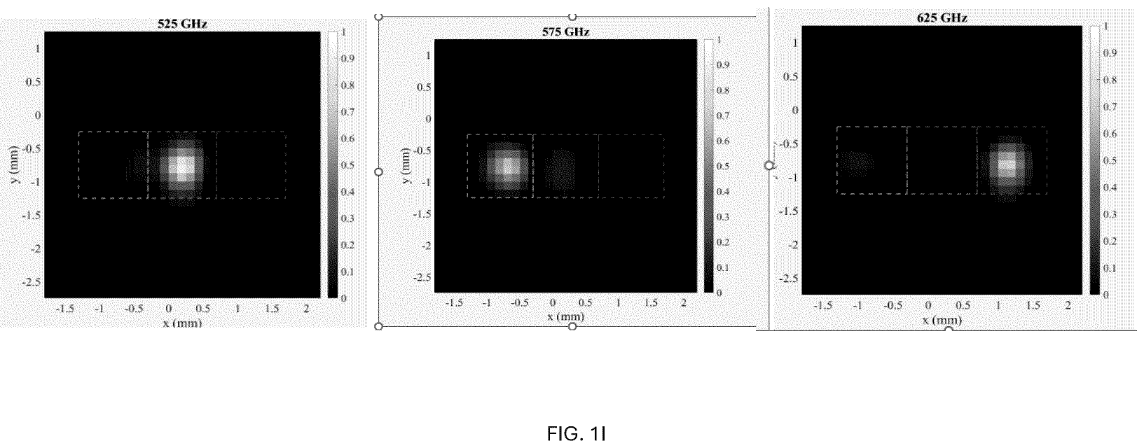

FIGS. 1A, 1B, 1C, and IF illustrate a device 100, comprising a stack 102 of silicon meta-optical layers 104 forming a meta-material comprising an input surface 106 for receiving terahertz electromagnetic radiation 108, an output surface 110 for outputting a plurality of beams 112 of the electromagnetic radiation; and a spatially varying permittivity varying with sub-wavelength precision across a volume of the stack. The spatially varying permittivity is configured to focus different spectral bands of the electromagnetic radiation into different spatially separated electromagnetic modes 114.

For the FIG. 1F simulations of transmission, there is assumed to be no oxide between the silicon layers of the volumetric meta-optical element, although there could be oxide between the layers in theory. In embodiments wherein the Si layers are directly bonded (Si—Si bonding), no oxide is present.

The meta-optics are made of multiple Silicon layers stacked directly on top of one another. At terahertz frequencies, the layers can be patterned and aligned with deep subwavelength accuracy. For the embodiments tested herein, the shapes of the layers are designed with adjoint-based inverse-design methods to identify an optimal shape for the full 3D device. The optimization procedure is general, allowing for arbitrary sets of inputs to be mapped to arbitrary sets of outputs. The input and outputs can be based on not only spectral properties, but also spatial and polarization properties, making this a promising platform for multi-functionality.

Thus, no matter the type of direct detectors used, and no matter the modes incident on the meta-optics, a high-performing solution can typically be found to maximize coupling over a broad frequency range.

### First Spectrometer Embodiment

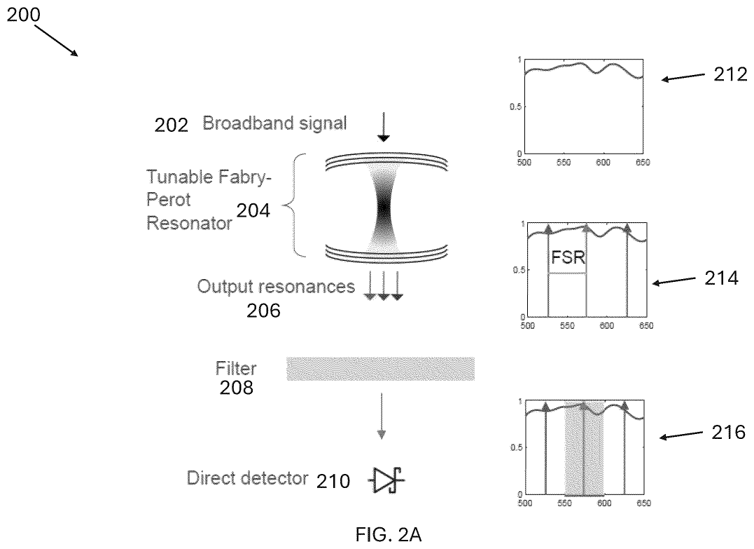

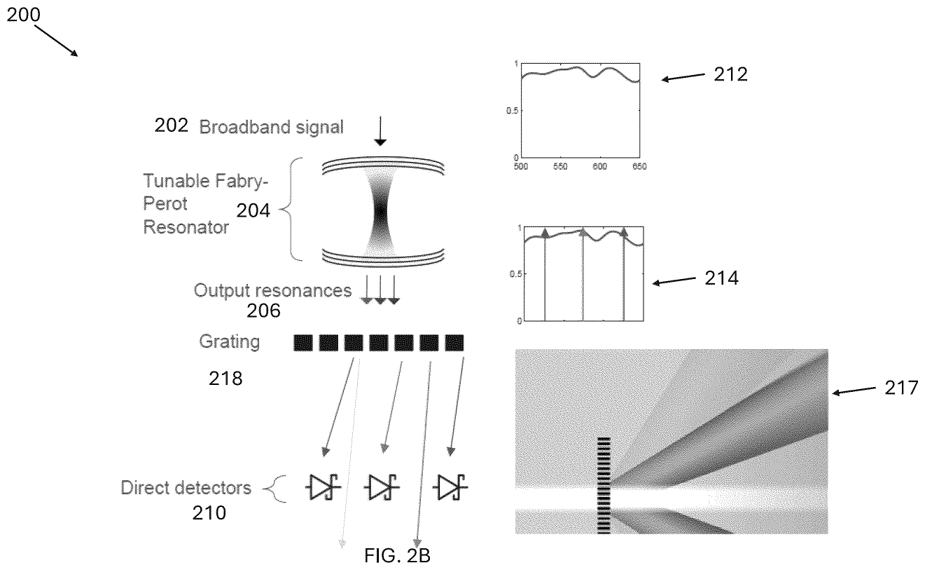

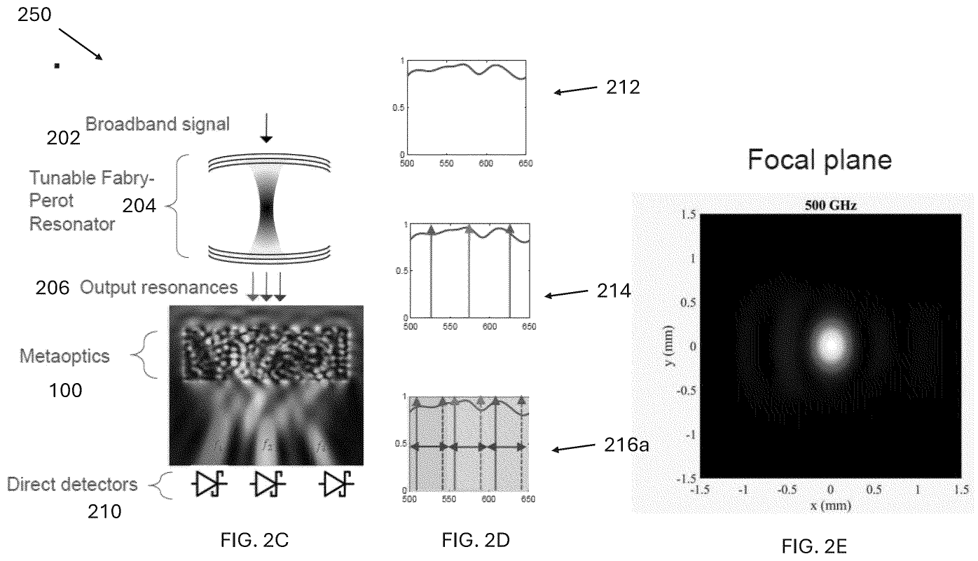

FIG. 2A-2C illustrate how a tunable resonator 204 (such as a Fabry-Perot cavity with a tunable length between mirrors) can be implemented as a high resolution spectrometer 200 when coupled with a sensitive direct detector 210 and receiving a broadband signal 202, 212. However, the resonator outputs a sequence of resonances 214 separated by a free-spectral range (FSR), and to avoid ambiguity these resonances must be either filtered out using a filter 208, as illustrated in FIG. 2A, which limits the bandwidth of the resonator to one FSR 216, or must be spatially separated such that the system can simultaneously measure the different resonances. The traditional way of separating the resonances would be to use a blazed grating 218, as illustrated in FIG. 2B, but this necessitates a long propagation length between the grating and sensor array. Furthermore, the continuous dispersion 217 of a grating causes the coupling efficiency to the detectors to only be optimal at discrete frequencies, rather than over a continuous band.

The meta-optical device 100 described herein can be used to enhances resonator-based spectrometers and overcome these limitations. FIG. 2C illustrates the volumetric meta-optics element 100 replacing the grating and placed immediately after the FP cavity. A detector 210 array is in-turn placed immediately (approximately two wavelengths) after the meta-optics element, enabling an extremely compact spectrometer element. The coupling efficiency of the electromagnetic modes to the detectors can be optimized 216 for increased overlap with each of the direct detectors and in a much more compact volume that does necessarily rely on free space propagation to separate the spectral bins (the spatial separation of the spectral bins occurs primarily within the device rather than the free space outside the device, so that the detectors can be positioned much closer to the output of the device relative to the grating configuration).

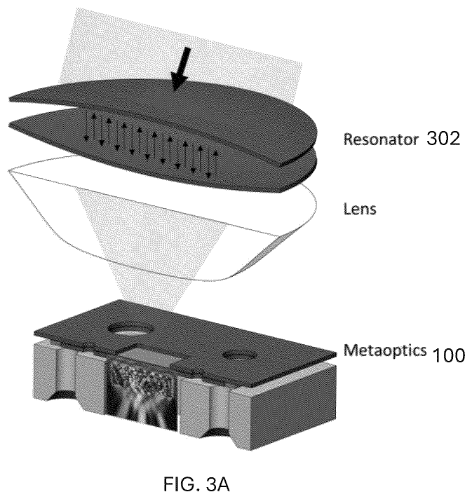

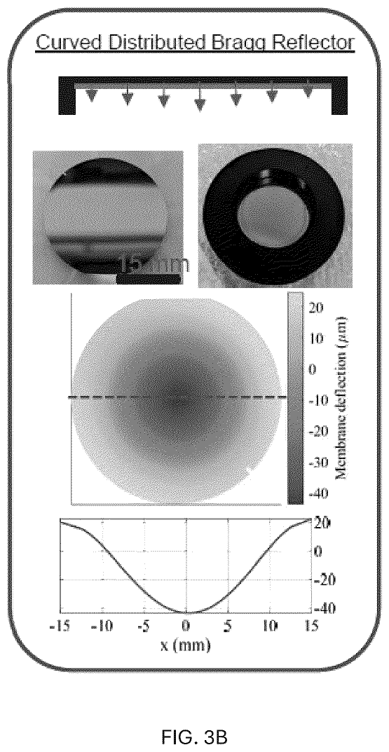

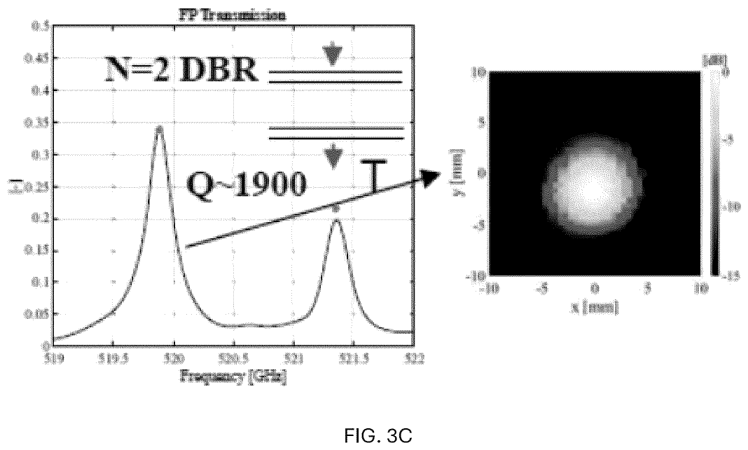

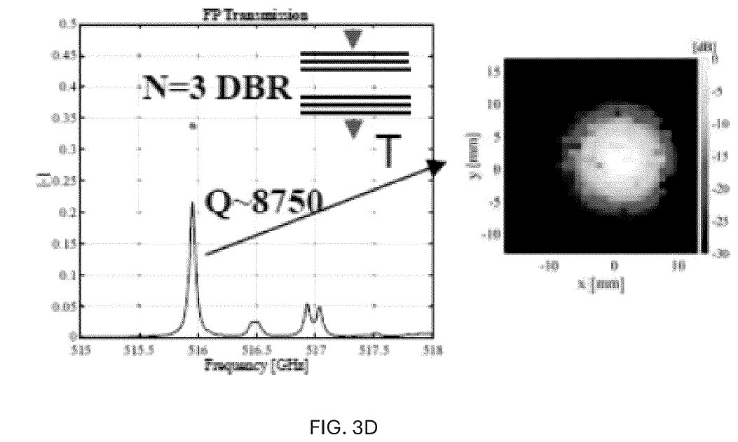

FIG. 3A-3C illustrate the prototype system is a R˜10⁴ spectral resolution spectrometer 300 operating at 500-650 GHz, and based entirely on Silicon micro-fabricated parts. A 10\hat{ }5 spectra; resolution is possible with this technique through a combination of increasing mirror reflectivity and increasing cavity length of the resonator 302.

The FP-cavity is made from two distributed Bragg reflector mirrors comprised of Silicon and void. The distance between the mirrors is scanned with a piezoelectric nano-positioner to scan the resonances over one FSR. The Si membranes (comprising alternating silicon and air layers configured as a Distributed Bragg Reflectors forming the cavity mirrors) are curved by a thin SiO₂ film, which causes the fundamental mode of the cavity to be compressed to a small Gaussian beam. The FSR of the cavity is 50 GHz, thus dividing the 500-650 GHz into three bands. The cascaded meta-optics device focuses these three bands onto three direct detectors.

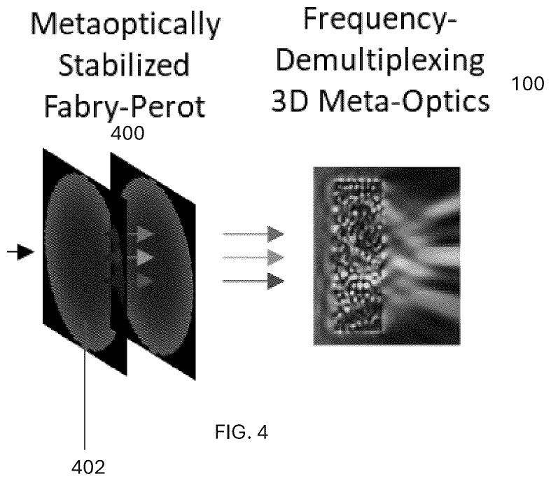

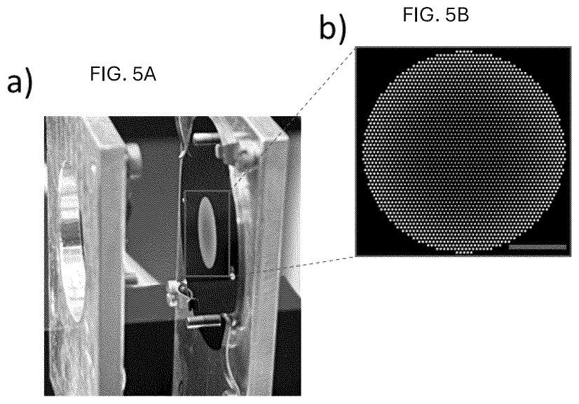

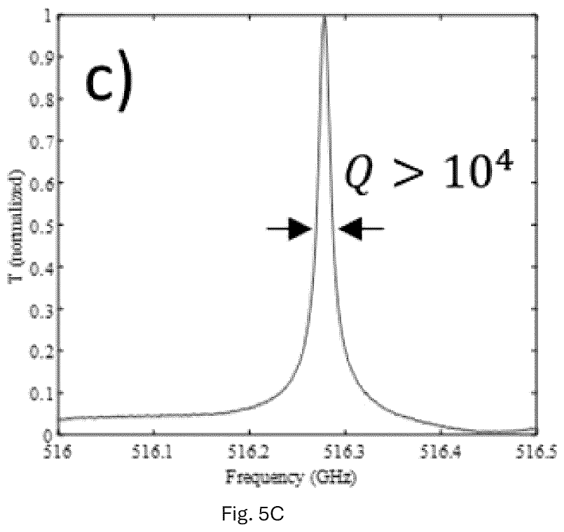

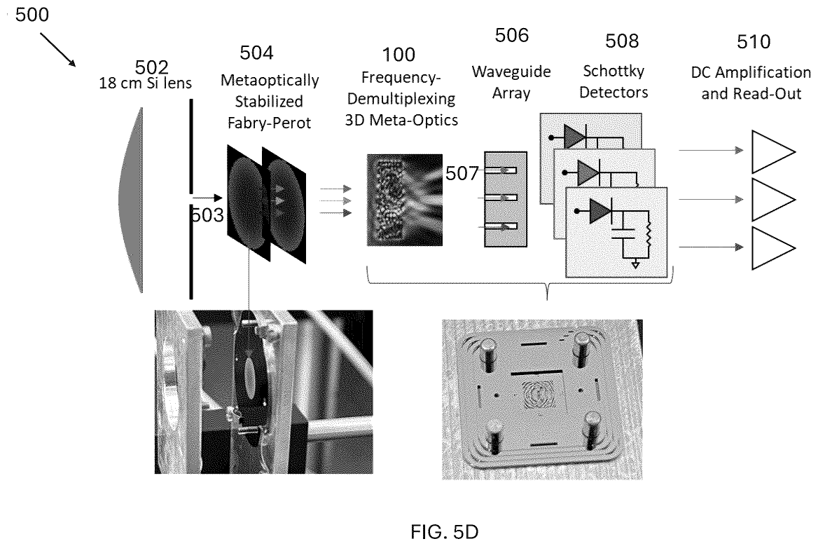

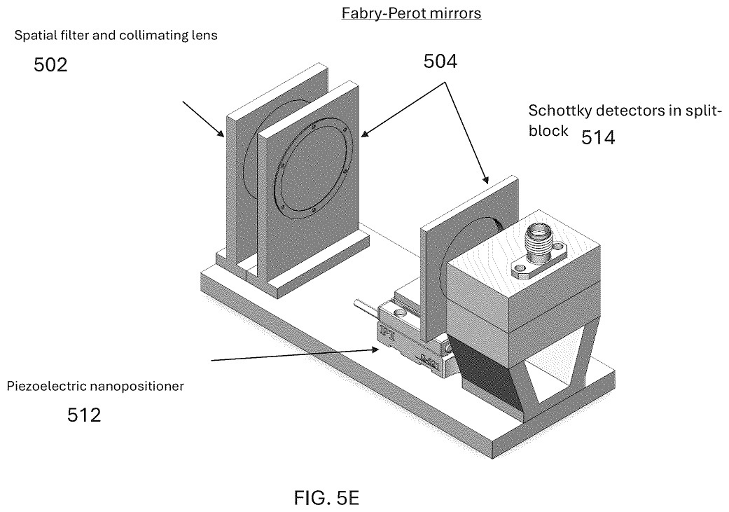

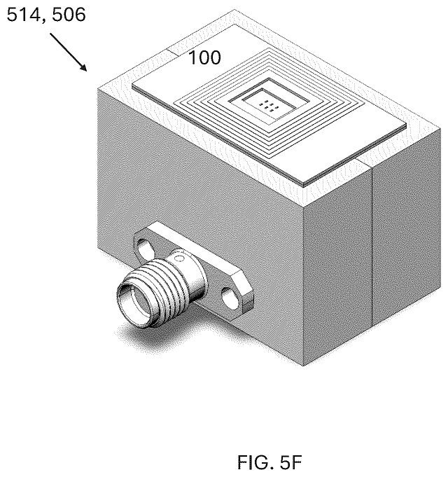

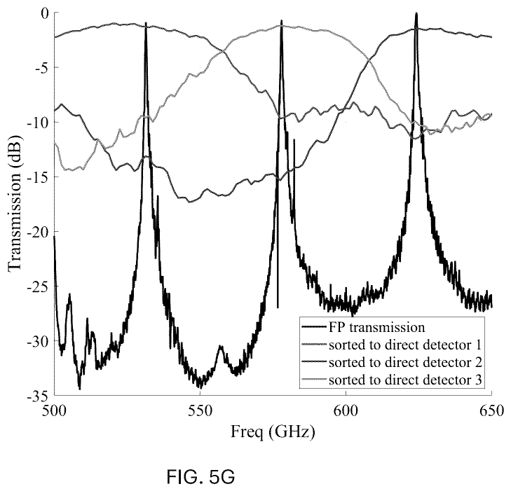

Although FIG. 3B illustrates the resonator comprising curved mirrors, the cavity 400 can also comprise flat meta-surface mirrors 402 as illustrated in FIG. 4. As for the curved mirrors, the mirrors each comprise a stack of alternating silicon and air layers forming a membrane comprising a Distributed Bragg Reflector (DBR). In the example of a flat metasurface mirror illustrated in FIGS. 5A-5C, however, a first external layer of the DBR is patterned with holes to form the metasurface. The mirrors are coupled to a piezoelectric actuator scanning a separation between the membranes forming the mirrors of a Fabry Perot cavity.

FIG. 5D-5F illustrate a spectrometer 500 according to the first embodiment, comprising (e.g., silicon) lens 502 focusing electromagnetic radiation onto a meta-optically stabilized Fabry Perot cavity 504 comprising planar mirrors; frequency de-multiplexing using 3D meta-optics 100, a waveguide array 506 coupling the different spectral bands 507 in different spatially separated electromagnetic modes outputted from the 3D meta-optical element, to each of a plurality of different Schottky detectors 508, and wherein the output of the Schottky detectors is coupled to DC amplification and readout circuitry 510. A piezoelectric nanopositioner 512 can be used to position one of the mirrors of the cavity. The waveguide array and Schottky detectors can be positioned in a split block 514 (metal block).

In this embodiment, a method for performing spectroscopy comprises receiving, in a single resonator 504, electromagnetic radiation after interaction with a target sample; scanning a cavity length of a single resonator across resonances of a free spectral range of the resonator; and coupling an output of the single resonator to the volumetric meta-optical device 100 that focuses the electromagnetic radiation outputted from a single resonator onto an array of detectors. The detectors 508 each have a sensitivity tuned or selected for a different one of the spectral bands and each output an output signal in response thereto. The output signals can be analyzed (e.g., using a computer) to determine the frequency response of the target sample to each of the different spectral bands.

### Second Spectrometer Embodiment

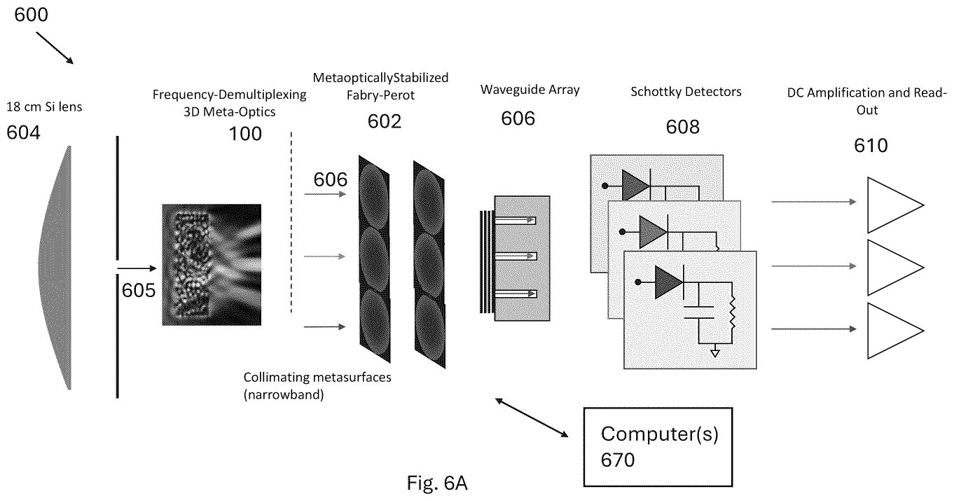

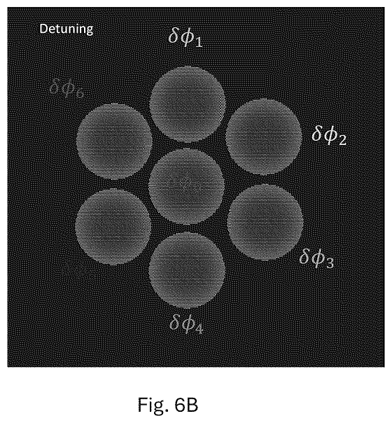

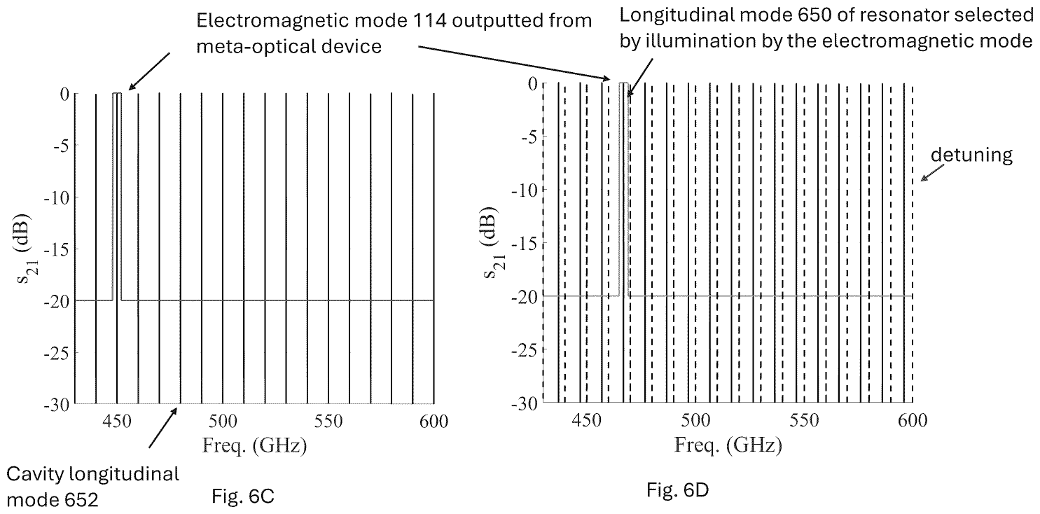

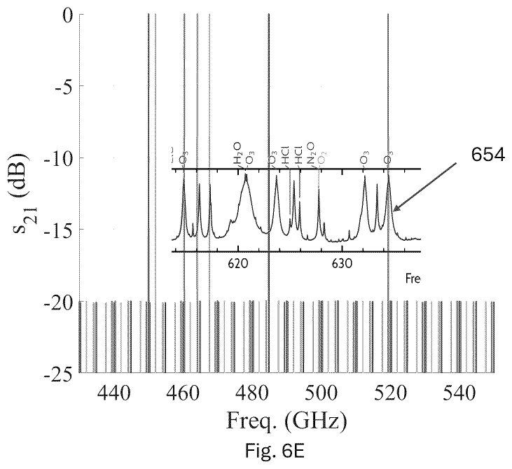

FIG. 6A illustrates a spectrometer 600 according to a second embodiment and comprising an array of resonators 602 coupled to an output of the volumetric meta-optical element 100. Each of the resonators comprises a cavity that can be detuned via an erosion or dilation of the cavity metasurface mirror features such that a longitudinal resonance roughly aligns with a spectral line of interest. Each of the resonators are configured to scan across the spectral line associated with the resonator.

FIG. 6A further illustrates the spectrometer comprises a silicon lens 604 focusing electromagnetic radiation 605 from the target onto the frequency de-multiplexing using 3D meta-optics, each of the different spatially separated and non-overlapping electromagnetic modes 606 outputted from the meta-optics each coupled (via narrowband collimating metasurfaces) to a different one of a plurality of meta-optically stabilized Fabry Perot resonators 602, a waveguide array 606 coupling the outputs from each of the resonators to a different one of a plurality of different Schottky detectors 608, and wherein the output of the Schottky detectors is coupled to DC amplification and readout circuitry 610.

FIG. 6B illustrates detuning of the Fabry Perot resonators via the metasurface enables simultaneous/multiplexed detection of spectral lines and prevents phase-locking of the array. FIG. 6C illustrates an Electromagnetic mode 114 outputted from meta-optical device and how a specific longitudinal mode 650 (of possible modes 652) of the resonator is selected by illumination by the electromagnetic mode 114. FIG. 6E illustrates arbitrarily placed detection lines align with spectral lines 654 of interest.

Thus, a method for performing spectroscopy illustrated in FIG. 6A comprises focusing different spectral bands of electromagnetic radiation (received from a target sample) into different spatially separated and non-overlapping electromagnetic modes (using the volumetric meta-optical device described herein); collecting the modes on an array of resonators, wherein each of the resonators receives a different one of the electromagnetic modes focused by the volumetric device; and coupling the electromagnetic radiation outputted from the array of resonators to an array of detectors, so that each array received the electromagnetic radiation from a different one of the resonators (i.e., the nth detector receives the electromagnetic radiation from the nth resonator).

In one embodiment, each of the resonators are de-tuned from different known spectral line associated with that resonator. More specifically, the method further comprises, for each of the 1<i≤n resonators, scanning a cavity length of the i^{th} resonator to scan a longitudinal resonant mode of the ith resonator across at least a portion of a linewidth of the ith spectral line; detecting the electromagnetic radiation outputted from the ith resonator on the ith one of the detectors; and generating the output signals in response thereto. The method can then further comprise analyzing the output signals to determine the frequency response of the target sample to the electromagnetic radiation at one or more (or each of) the frequencies of one or more of the spectral lines.

In another embodiment, the electromagnetic radiation is received after interaction with a target sample, and each of the resonators are de-tuned from a different known spectral line in a set of target spectral lines 610 (e.g., of molecules, atoms, gases, liquids, or other materials of interest, e.g., in an atmosphere), the method further comprising scanning cavity lengths of the resonators together, so that one longitudinal resonant mode 650 of each of the resonators 602 is only scanned across a spectral portion encompassing the one of the target spectral lines 654 associated with that one of the resonators, wherein the array of resonators collectively scans across all the spectral lines in the set (i.e., for 1 <i<n resonators, electromagnetic modes 114, spectral lines, and detectors, a longitudinal mode of the i^{th} resonator, selectively illuminated by the i^{th} one of the electromagnetic modes 114 outputted from volumetric device 100, is scanned across a spectral portion of the i^{th} spectral line); detecting the electromagnetic radiation outputted from each of the resonators on an array of detectors 608 generating the output signals in response thereto (so that the i^{th} one of the detectors detects the electromagnetic radiation from the i^{th} one of the resonators); and analyzing the output signals to determine a response of the target sample to the electromagnetic radiation at one or more frequencies of the known spectral lines.

In one or more embodiments, the analyzing comprises determining at least one of an absorption or scattering of the electromagnetic radiation at one or more of the frequencies of the spectral line (e.g., for each of the i spectral lines), or comparing a line-shape of the electromagnetic radiation measured at the detectors with a line shape of the spectral line in a presence of a control sample. One or more computers 670 (e.g., comprising one or more processors and memories executing a program, or application specific integrated circuit, or field gate programmable array or circuit/circuitry) and motor 514 can be included in the spectrometer or coupled to one or more components of the spectrometer to perform analysis or scanning or other functionalities, or control the spectrometer, as described herein.

The volumetric meta-optics device can be placed directly on single-mode waveguide array that couples to the arrayed Fabry-Perot cavities in a tiled configuration.

Since all elements (including the detectors) can be tuned to a specific spectral line, scanning can be done in parallel to achieve multiplexed detection.

### Method of Fabricating

### Etching

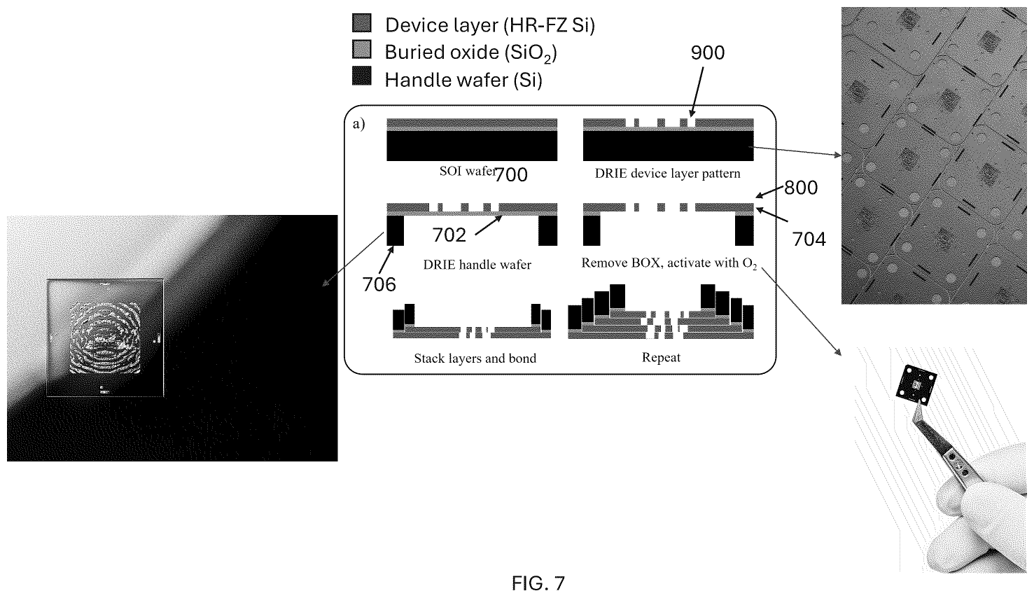

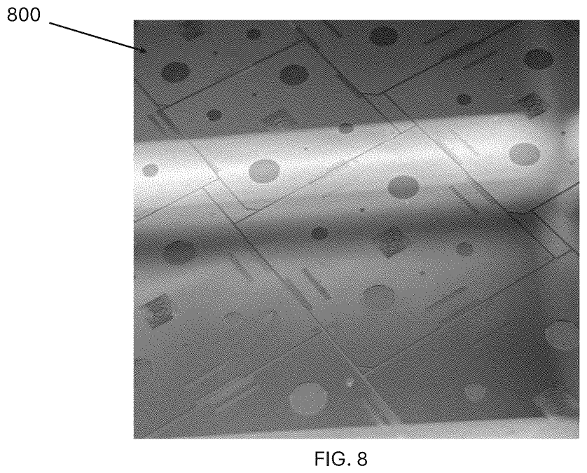

FIGS. 7 and 8 illustrate a method of fabricating the meta-optical device.

The first step comprises photolithographically etching a plurality of regions of a silicon on oxide (SOI) wafer 700 using an oxide layer 702 in the wafer as an etch stop, so as to define a plurality of dies 800 each comprising a different one of the silicon layers 704 and a handle portion 706 of the wafer. For the devices fabricated and tested herein, the wafer was patterned with photoresist using photolithography and the etch pattern was transferred to the silicon using a Bosch process.

The silicon on oxide wafer comprises a layer of high resistivity float zone silicon (high resistivity for the terahertz electromagnetic radiation, e.g., resistivity greater than 10 kohm-cm). For the data presented herein, the silicon layers have a thickness of 40 microns, however this thickness can be optimized for different applications and frequencies of operation. The layers typically have a thickness less than a wavelength of the terahertz electromagnetic radiation in free space.

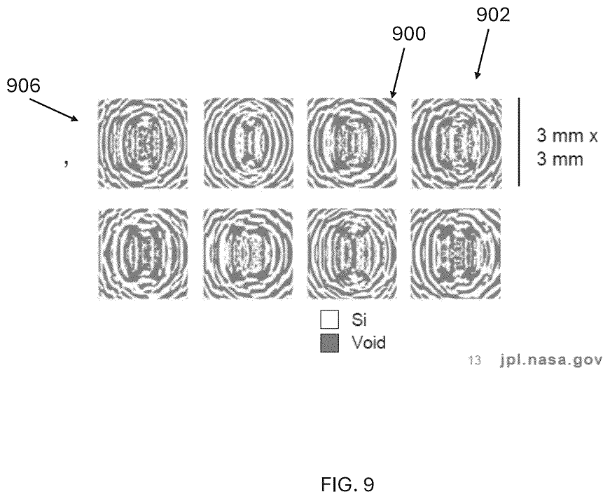

FIG. 9 illustrates each of the silicon layers are etched to comprise a thickness and a pattern of openings 902 through the thickness of the layer and are connected around their edge or perimeter to the handle portion. The openings are patterned to spatially tailor the permittivity as described herein. NOTE: the silicon is fully connected during optimization for mechanical robustness and does not rely on oxide layer for connectivity.

Next, the dies are separated and assembled one on top of the other so as to stack the silicon layers using the handle portions for alignment. The next step comprises bonding the silicon layers together using fusion bonding to form a stack of silicon layers. For the devices tested herein, the bonding comprises room temperature silicon to silicon direct bonding. In some embodiments, the handle portion of the bottom die in the stack has less of the handle wafer etched away. to provide increased rigidity to support the remaining silicon layers during the bonding process.

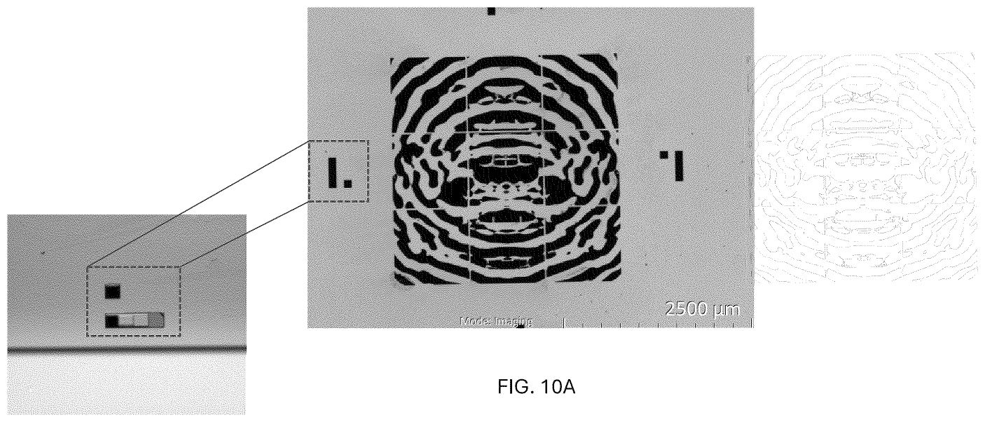

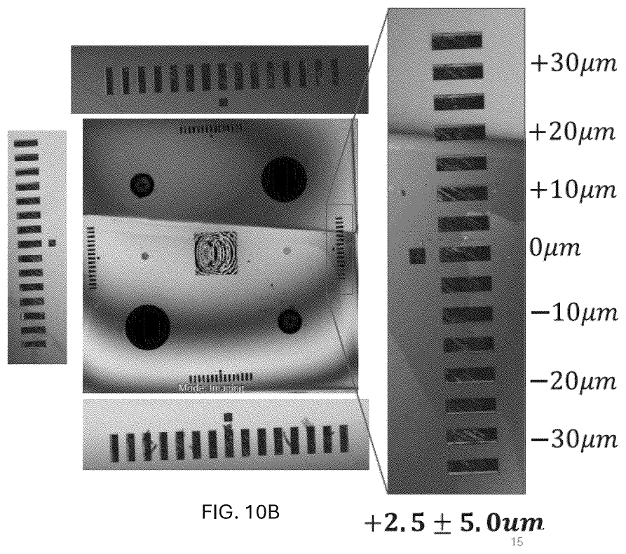

In order to position the silicon layers with the correct alignment, the areas of the dies are progressively designed to be smaller so that the dies can be assembled into a nested stack aligned by the handle portions. FIGS. 10A and 10B illustrates the layers can be positioned with +/−5 micron accuracy, and 2 micron accuracy is also possible.

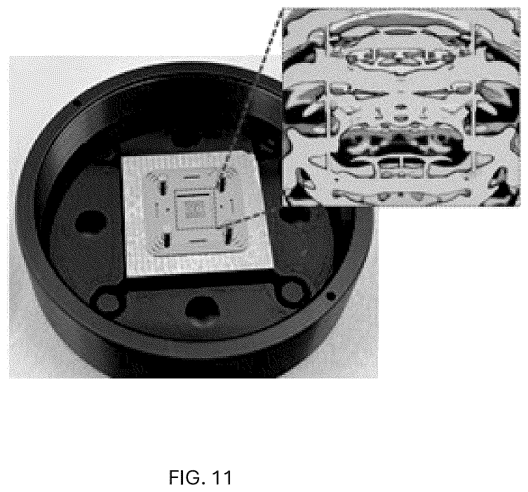

FIG. 11 illustrates mounting the stack in a support mount (e.g., using pins inserted in through holes patterned in the dies).

### Inverse Design

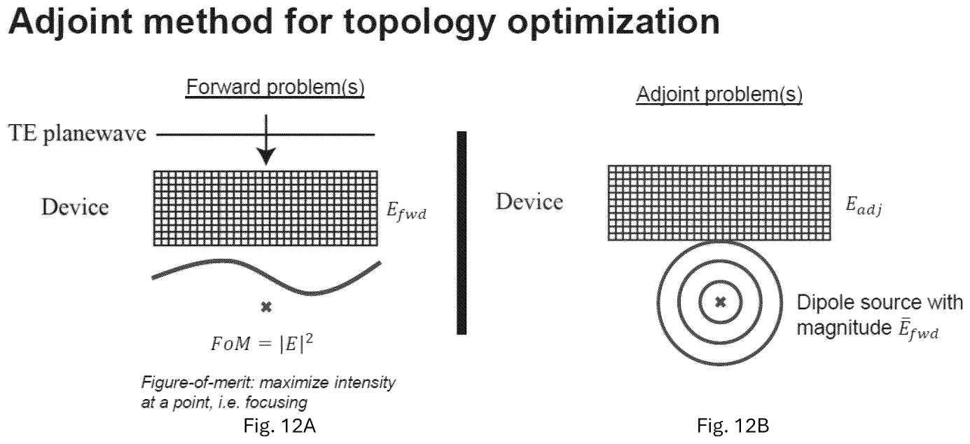

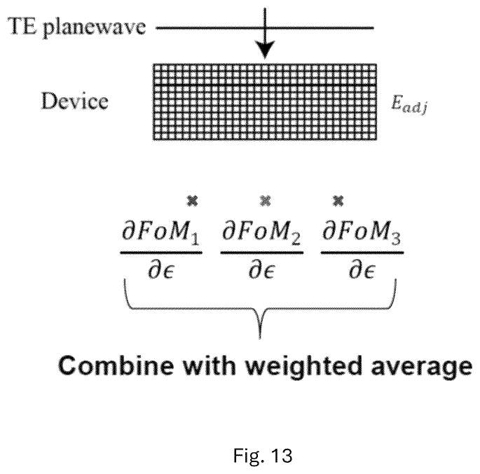

FIG. 12 and FIG. 13 illustrate how the pattern of openings (corresponding to the voids patterning the permittivity) is determined using an inverse design method. The inverse design method comprises using a gradient based optimization to iteratively find the optimal permittivity distribution of the meta-optical elements that focuses a transverse electric (TE) plane wave of the electromagnetic radiation received on the input face to a plurality of the electromagnetic modes/comprising the different resonances, e.g., different longitudinal modes of a single resonator, different detuned modes of a plurality of resonators, or different spectral bands (e.g., longitudinal resonant modes separated by a free spectral range).

The gradient can comprise the differential of a figure of merit, e.g., intensity at a point or a waveguide mode coupling) as a function of the permittivity of the meta-optical elements for each of the resonances/spectral ranges. The optimization uses a numerical method to iteratively find the void/opening size and distribution that maximizes the figure of merit, by changing the void/opening size and distribution at each iteration step until the figure of merit converges to a local optimum.

### Possible Modifications and Variations

The volumetric meta-optical device described herein can be designed (e.g., as a lens using inverse design) for a variety of applications beyond spectroscopy.

### Example Embodiments

The device, systems, and methods can be embodied in many ways including, but not limited to, the following (referring also to FIGS. 1-15)

1. A device 100, comprising:
a stack 102 of silicon meta-optical layers 104 forming a meta-material comprising an input surface 106 for receiving terahertz (e.g., 0.3 THz-3 THz) electromagnetic radiation 108, an output surface for outputting a plurality of beams 112 of the electromagnetic radiation; and a spatially varying permittivity varying with (e.g., sub-wavelength precision) across a volume of the stack, wherein the spatially varying permittivity is configured to focus different spectral bands of the electromagnetic radiation into different spatially separated electromagnetic modes 114.

2. The device of clause 1, wherein the meta-optical elements each comprise a distribution of voids 900 comprising a shape and dimension patterning the spatially varying permittivity, wherein the sub-wavelength precision comprises a feature size of the voids that less than one or more wavelengths of the terahertz electromagnetic radiation.

3. The device of clause 1 or 2, wherein the spectral bands each comprise a resonance of a free spectral range (FSR) of a resonator 602.

4. The device of clause 1 or 2 or 3, wherein silicon surfaces of the meta-optical layers are bonded together to prevent, suppress, or eliminate air gaps between the layers.

5. The device of any of the clauses 1-4, wherein:
each of the meta-optical layers comprises an electromagnetic meta-surface comprising a thickness T and a two dimensional pattern 902 of voids through the thickness; and
the thickness is less than all the wavelengths of the terahertz electromagnetic radiation

6. The device of any of the clauses 1-5, wherein the thickness is less than or equal to a quarter of the longest of the wavelengths in free space.

7. The device of clause 6 wherein each of the meta-optical layers comprises a continuous piece of silicon 906 that is self-supporting.

8. The device of any of the clauses 1-7, comprising at least 4 of the silicon layers and wherein each of the silicon layers has a different pattern for the spatially varying permittivity.

9. A spectrometer 500, 600 comprising a resonator 504, 602 coupled to the stack 102 of meta-optical layers 104 of any of the clauses 1-8.

10. The spectrometer 500 of clause 9, wherein the spectral bands each comprise a different one of a plurality of free spectral range resonances of the resonator, wherein the input surface is coupled to the output of the resonator 504 to receive the electromagnetic radiation; and further comprising an array of direct detectors 508 coupled to the output surface each positioned to receive a different one of the electromagnetic modes

11. A spectrometer 600 comprising the device of any of the clauses 1-9, comprising:
an array of direct detectors 602 or resonators 608 coupled to the output surface 110 of the metamaterial 100 and positioned to receive a different one of the electromagnetic modes.

12. The spectrometer 600 of clause 11, wherein each of the resonators 602 comprises a cavity detuned from a different spectral line and the resonators are configured to scan longitudinal modes of the resonator across the spectral line.

13 The spectrometer or device of any of the clauses 1-12, wherein the electromagnetic modes are spaced less than two of the longest one of the wavelengths apart in a lateral direction.

14. The spectrometer of any of the clauses 1-13, wherein the resonator comprises a coupled pair of membranes 402 (DBR air silicon) coupled by a piezoelectric actuator scanning a separation between the membranes.

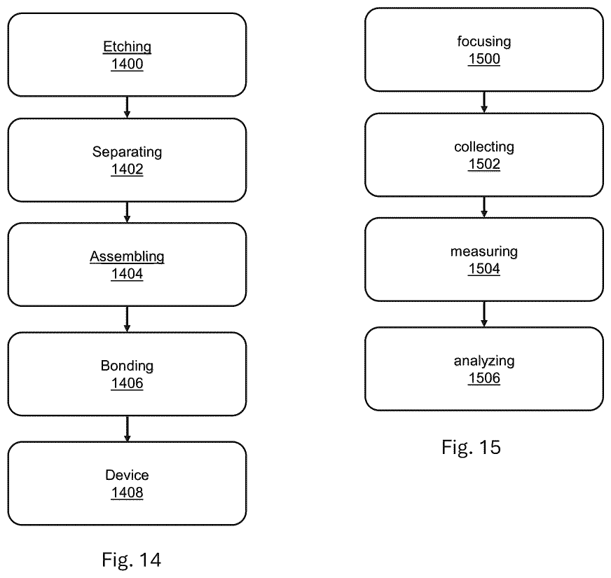

15. FIG. 14A method of making a meta-optical device, comprising:
photolithographically etching (Block 1400) a plurality of regions of a silicon on oxide wafer using an oxide layer in the wafer as an etch stop, to define a plurality of dies each comprising a different one of a plurality of silicon layers and a handle portion of the wafer, each of the silicon layers comprising a thickness and a pattern of openings through the thickness of the layer and connected at an edge to the handle portion;
separating the dies (Block 1402);
assembling (Block 1404) the dies to stack the silicon layers using the handle portions for alignment; and
bonding (Block 1406) the silicon layers together using fusion bonding to form a stack of silicon layers (Block 1408), wherein the pattern of openings define a spatially varying permittivity of the stack configured to focus different spectral bands of electromagnetic radiation into different spatially separated electromagnetic modes.

16. The method of clause 15, wherein areas of the dies are progressively smaller so that the dies can be assembled as a nested stack aligned by the handle portions.

17. The method of clause 14 or 15, wherein the pattern of openings is determined using an inverse design method.

18. The device or any of the embodiments 1-14 manufactured using the method of any of the embodiments 15-17.

19. FIG. 15 illustrates a method of performing spectroscopy, comprising:
focusing (Block 1500) different spectral bands of electromagnetic radiation into different spatially separated and non-overlapping electromagnetic modes;
collecting (Block 1502) the modes on an array of detectors or resonators, wherein each of the first detectors or resonators receives a different one of the electromagnetic modes; and
measuring (Block 1504) an output signal from each of the detectors or the resonators and optionally analyzing the signal (Block 1506).

20. The method of embodiment 19, wherein the electromagnetic radiation is received after interaction with a target sample, and each of the resonators are de-tuned from a different known spectral line in a set of target spectral lines 610 (e.g., of molecules, gases, or other materials of interest), the method further comprising:
scanning cavity lengths of the resonators together, so that one longitudinal resonant mode 650 of each of the resonators 602 is only scanned across a spectral portion encompassing the one of the target spectral lines 654 associated with that one of the resonators, wherein the array of resonators collectively scans across all the spectral lines in the set (i.e., for 1<i<n resonators, electromagnetic modes 114, spectral lines, and detectors, a longitudinal mode of the i^{th} resonator, selectively illuminated by the i^{th} one of the electromagnetic modes 114 outputted from volumetric device 100, is scanned across a spectral portion of the i^{th} spectral line);
detecting the electromagnetic radiation outputted from each of the resonators on an array of detectors 608 generating the output signals in response thereto, (so that the i^{th} one of the detectors detects the electromagnetic radiation from the i^{th} one of the resonators); and
analyzing the output signals to determine a response of the target sample to the electromagnetic radiation at one or more frequencies of the known spectral lines.

20. The method of clause 18, wherein the electromagnetic radiation is received after interaction with a target sample, and each of the resonators are de-tuned from a different known spectral line, the method further comprising:
for each of the resonators, scanning a cavity length of the resonator to scan a longitudinal resonant mode of the resonator across at least a portion of a linewidth of the known spectral line associated with the one of the resonators;
detecting the electromagnetic radiation outputted from each of the resonators on an array of second detectors generating the output signals in response thereto; and
analyzing the output signals to determine a response of the target sample to the electromagnetic radiation at one or more frequencies of the known spectral lines.

21 The method of clause 19, wherein the analyzing comprises determining at least one of an absorption or scattering of the electromagnetic radiation at one or more of the frequencies of the known spectral lines, or comparing a line-shape of the electromagnetic radiation at the frequencies with a line shape of the spectral line in a presence of a control sample.

22 The method of any of the embodiments 19-21 performed using the device of one or more of the embodiments 1-14.

23 The method of any of the embodiments 19-21 wherein the resonators are not scanned in frequency ranges that do not comprise the frequencies of the spectral lines.

24 The method or device of any of the embodiments 1-23, wherein the spatial variation in permittivity is periodic or non-periodic.

25. The method or device of any of the embodiments 1-23, wherein the spatially varying permittivity causes scattering of the electromagnetic radiation within the volume of the stack to re-distribute the different spectral bands into the spatially separated electromagnetic modes.

26. The method or device of any of the embodiments 1-25, wherein the electromagnetic modes of outputted from the metamaterial selectively illuminate a longitudinal mode of the resonator.

27. The method or device of any of the embodiments 1-26, wherein the voids comprise or consist of or consist essentially of air (or an absence of the silicon).

28. The method or device of any of the embodiments 1-27, wherein the silicon layers comprise a spatially varying amount of silicon (presence or absence of silicon), spatially varying refractive index, and/or spatially varying presence of voids or openings, e.g., spatially varying across the two dimensional plane/area of the layer.

29. The method or device of any of the embodiments 1-28, wherein the spatially varying permittivity ε (e.g., electric polarizability of the dielectric material in the layer e.g., in response to the terahertz electromagnetic radiation) is tailored such that the metamaterial comprises a lens focusing different spectral bands of the electromagnetic radiation to spatially separated and non-overlapping locations.

30. One or more computers 670 (e.g., comprising one or more processors and memories executing a program, or application specific integrated circuit, or field gate programmable array) and motor 514 can be included in the spectrometer or coupled to one or more components of the spectrometer or device of any of the embodiments 1-29 to perform analysis or scanning or other functionalities described herein.

### REFERENCES

The following references are incorporated by reference herein.
[1] US patent publication No. 20230122182, U.S. Pat. No. 11,397,331, US patent publication Nos. 20210118938 and 20200124866.
[2] Philip Camayd-Muñoz, Conner Ballew, Gregory Roberts, and Andrei Faraon, “Multifunctional volumetric meta-optics for color and polarization image sensors,” Optica 7, 280-283 (2020)
[3] Roberts, G., Ballew, C., Zheng, T. et al. 3D-patterned inverse-designed mid-infrared metaoptics. Nat Commun 14, 2768 (20237
[4] Ballew, C., Roberts, G., Camayd-Muñoz, S. et al. Mechanically reconfigurable multi-functional meta-optics studied at microwave frequencies. Sci Rep 11, 11145 (2021). https://doi.org/10.1038/s41598-021-88785-5
[5] Conner Ballew, Gregory Roberts, and Andrei Faraon, “Multi-dimensional wavefront sensing using volumetric meta-optics,” Opt. Express 31, 28658-28669 (2023)
[6] Constraining Continuous Topology Optimizations to DiscretConner Ballew, Gregory Roberts, Tianzhe Zheng, and Andrei Faraon ACS Photonics 2023 10 (4), 836-844DOI: 10.1021/acsphotonics.2c00862 e Solutions for Photonic Applications.

Further information on inverse design methods can be found in the above references.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device, comprising:
a stack of silicon meta-optical layers forming a meta-material comprising an input surface for receiving terahertz electromagnetic radiation, an output surface for outputting a plurality of beams of the electromagnetic radiation; and a spatially varying permittivity varying with sub-wavelength precision across a volume of the stack, wherein the spatially varying permittivity is configured to focus different spectral bands of the electromagnetic radiation into different spatially separated electromagnetic modes.

2. The device of claim 1, wherein the meta-optical elements each comprise a distribution of voids comprising a shape and dimension patterning the spatially varying permittivity, wherein the sub-wavelength precision comprises a feature size of the voids that less than one or more wavelengths of the terahertz electromagnetic radiation.

3. The device of claim 1, wherein the spectral bands each comprise a resonance of a free spectral range of a resonator.

4. The device of claim 1, wherein silicon surfaces of the meta-optical layers are bonded together to prevent, suppress, or eliminate air gaps between the layers.

5. The device of claim 1, wherein:
each of the meta-optical layers comprises an electromagnetic meta-surface comprising a thickness and a two dimensional pattern of voids through the thickness; and
the thickness is less than all the wavelengths of the terahertz electromagnetic radiation

6. The device of claim 1, wherein the thickness is less than or equal to a quarter of the longest of the wavelengths in free space.

7. The device of claim 6 wherein each of the meta-optical layers comprises a continuous piece of silicon that is self-supporting.

8. The device of claim 1, comprising at least 4 of the silicon layers and wherein each of the silicon layers has a different pattern for the spatially varying permittivity.

9. A spectrometer comprising a resonator coupled to the stack of meta-optical elements of claim 1.

10. The spectrometer of claim 9, wherein the spectral bands each comprise a different one of a plurality of free spectral range resonances of the resonator, wherein the input surface is coupled to the output of the resonator to receive the electromagnetic radiation; and further comprising an array of direct detectors coupled to the output surface each positioned to receive a different one of the electromagnetic modes

11. A spectrometer comprising the device of claim 1, comprising:
an array of direct detectors or resonators coupled to the output surface of the metamaterial and positioned to receive a different one of the electromagnetic modes.

12. The spectrometer of claim 11, wherein each of the resonators comprises a cavity detuned from a different spectral line and the resonators are configured to scan longitudinal modes of the resonator across the spectral line.

13. The device of claim 1, wherein the electromagnetic modes are spaced less than two of the longest one of the wavelengths apart in a lateral direction.

14. The spectrometer of claim 9, wherein the resonator comprises a coupled pair of membranes (DBR air silicon) coupled by a piezoelectric actuator scanning a separation between the membranes.

15. A method of making a meta-optical device, comprising:
photolithographically etching a plurality of regions of a silicon on oxide wafer using an oxide layer in the wafer as an etch stop, to define a plurality of dies each comprising a different one of a plurality of silicon layers and a handle portion of the wafer, each of the silicon layers comprising a thickness and a pattern of openings through the thickness of the layer and connected at an edge to the handle portion;
separating the dies;
assembling the dies to stack the silicon layers using the handle portions for alignment; and
bonding the silicon layers together using fusion bonding to form a stack of silicon layers, wherein the pattern of openings define a spatially varying permittivity of the stack configured to focus different spectral bands of electromagnetic radiation into different spatially separated electromagnetic modes.

16. The method of claim 15, wherein areas of the dies are progressively smaller so that the dies can be assembled as a nested stack aligned by the handle portions.

17. The method of claim 15, wherein the pattern of openings is determined using an inverse design method.

18. A method of performing spectroscopy, comprising:
focusing different spectral bands of electromagnetic radiation into different spatially separated and non-overlapping electromagnetic modes;
collecting the modes on an array of detectors or resonators, wherein each of the first detectors or resonators receives a different one of the electromagnetic modes; and
measuring an output signal from each of the detectors or the resonators.

19. The method of claim 18, wherein the electromagnetic radiation is received after interaction with a target sample, and each of the resonators are de-tuned from a different known spectral line in a set of target spectral lines, the method further comprising, for 1<i<n resonators, electromagnetic modes, spectral lines, and detectors, where i and n are integers:
scanning cavity lengths of the resonators together, so that the longitudinal resonant mode of each of the resonators is only scanned across the spectral portion encompassing the one of the target spectral lines associated with that one of the resonators, wherein the array of resonators collectively scans across all the spectral lines in the set (a longitudinal mode of the ith resonator, selectively illuminated by the i^{th} electromagnetic mode outputted from volumetric device, is scanned across a spectral portion of the ith spectral line);
detecting the electromagnetic radiation outputted from each of the resonators on an array of detectors generating the output signals in response thereto; and
analyzing the output signals to determine a response of the target sample to the electromagnetic radiation at one or more frequencies of the known spectral lines.

20. The method of claim 19, wherein the analyzing comprises determining at least one of an absorption or scattering of the electromagnetic radiation at one or more of the frequencies of the known spectral lines, or comparing a line-shape of the electromagnetic radiation at the frequencies with a line shape of the spectral line in a presence of a control sample.
